(19) United States
(12) Patent Application Publication
(10) Pub. No.: US 2020/0374259 A1
(43) Pub. Date: Nov. 26, 2020

(54) METHOD FOR PROCESSING MESSAGES IN A HIGHLY AVAILABLE NURSE CALL SYSTEM

(71) Applicant: STEPHEN GILES, JACKSONVILLE, FL (US)

(72) Inventor: STEPHEN GILES, JACKSONVILLE, FL (US)

(21) Appl. No.: 16/447,232

(22) Filed: Jun. 20, 2019

Related U.S. Application Data
(60) Provisional application No. 62/852,742, filed on May 24, 2019.

(51) Int. Cl. H04L 12/58; H04L 29/08

(52) U.S. Cl. CPC H04L 51/36; H04L 51/16; H04L 67/12

(57) ABSTRACT

A highly available nurse call system has one or more logic end-points (LEP), each one of which is comprised of two or more pairs of active and standby compute nodes. Each pair of compute nodes are configured to process particular types of messages that are different than each of the other pairs of compute nodes comprising the LEP. Any one of the active compute nodes operate to receive a message over a common communication network, and to send a copy of the message to a location in a persistent storage space that each of the other active compute nodes can examine. Each active compute node periodically examines the persistent storage location looking for a message that it is configured to process.

### 1. CROSS REFERENCE TO RELATED APPLICATIONS

This application claims the benefit under 35 U.S.C. § 119(e) of U.S. Provisional Patent Application Ser. No. 62/852,742 entitled “METHOD FOR PROVIDING SERVICES IN A SCALED-OUT HIGHLY AVAILABLE NURSE CALL SYSTEM”, filed May 24, 2019, the entire contents of which is incorporated by reference.

### 2. FIELD OF THE INVENTION

The present disclosure relates generally to a highly available nurse call system having a logical endpoint with two or more active compute nodes, with each active compute node being configured to process different types of messages.

### 3. BACKGROUND

Certain types of organizations, such as financial institutions, hospitals and data centers, benefit from services that are highly or continually available. Generally, hardware and software techniques can be employed, either alone or in some combination, to provide such highly available services. Such computer systems are generally referred to as highly available (HA) computer systems. For example, two (or more) physical computational devices (compute nodes) can be paired such that one, active node can fail-over to another, hot standby node in the event that the active node is unable to continue supporting a service, such as a computer application, in an error free manner, or at all. Additionally, depending upon the size of an organization or depending upon the amount of data needed to be processed with low latency during any period of time, it may be necessary to configure a HA computer system to have more than one active node. In this regard, an HA computer system can be configured to have one or more logical end points, with each one having two or more active/hot-standby compute node pairs, and with each of the active nodes being configured differently to provide services. An HA computer system logically configured in this manner is able to provide a high degree of service availability with low processing latency.

In a health care environment, messages generated by a communication device associated with a patient should be processed by a particular application or service that can be running on multiple compute nodes comprising a HA computer system connected to a healthcare network. However, in order to ensure that patient messages are only processed once, each compute node is typically configured differently so that it is only capable of processing messages received from particular organizations within a healthcare enterprise, and which are generated by particular types of communication devices. For example, a hospital patient or a healthcare provider (i.e., a nurse or doctor) assigned to a particular hospital function, such as an emergency room, can activate a communication device, such as a nurse call device, to initiate a message having information corresponding to a request for patient care, or a request for nurse assistance. This message should be routed over the network to a compute node that is running a service that is configured to receive and process information in messages from a particular communication device associated with that emergency room, and to respond to the message by generating one or more instructions to initiate an appropriate workflow process, such as generating and sending a message to a particular nurse the a patient needs assistance, or notifying one particular healthcare provider that another provider needs assistance, or tuning on a light at a nurse terminal. Each message generated by a nurse call device needs to be processed, and it should to be processed only once so that only the appropriate devices or hospital staff are involved with a particular workflow.

A particular type of communication bus, called a service bus, can be implemented in environments having multiple compute nodes, some or all of which run applications which communicate with each other. This service bus can also be implemented in an environment having a logical end-point comprised of multiple compute nodes, with each node performing the same or different function. Such a service bus is typically able to support one or more different types of brokered transport/message queueing services. Some queueing services implement sender-side message distribution, and other services implement receiver-side message distribution, but all of these services implement some form of message distribution that effectively results in the random delivery of messages to subscribing compute nodes. Further, certain types of service buses (i.e., NServicebus) operate in a manner that does not allow a message received by a logical end-point to be distributed on a conditionally basis to all compute nodes comprising the logical end-point.

### 4. BRIEF DESCRIPTION OF THE DRAWINGS

FIG. 1 is a diagram showing elements comprising a communication network 100.

FIG. 2 is a diagram showing the elements comprising an embodiment of one of the logical end points in FIG. 1.

FIG. 3 is a diagram showing the elements comprising another embodiment of one of the logical end points in FIG. 1.

FIG. 4 is a diagram showing functional elements comprising any of the compute nodes comprising a logical end point.

FIG. 5 is a diagram showing functional elements comprising a compute node.

FIG. 6 is a diagram showing a compute node configuration information format.

FIG. 7 is a logical flow diagram of a process followed by a computer node to process a message.

### 5. DETAILED DESCRIPTION

A logical end point (LEP) having two or more active compute nodes can be configured to subscribe to receive different types of messages from particular communication devices that are associated with a particular organization in an enterprise. Regardless of the message queueing service used to distribute messages generated by one device to a queue on another device (such as a compute node in a nurse call system) connected to a network, and due to the random process for distributing such messages to a compute node in a LEP having multiple active compute nodes, it is not possible to be sure that each message that is distributed will be delivered to a compute node that is configured to process the message (i.e., conditional message processing operation). And if the message is not distributed to the correct compute node, it will not be processed, resulting in a work flow not being initiated.

In order to guarantee that every message is distributed to a compute node that is configured to process that message, I have designed a nurse call system having at least one logical end-point which can operate to store a persistent copy of each message it receives. Each logical end-point can have two or more active compute nodes, each one of which is configured to process messages received from different devices associated with a particular organization. Each compute node that receives a message (regardless of the message type) operates to send a copy of the message to a location in a persistent storage system that can be examined by all of the compute nodes comprising the logical end-point. Each compute node can then examine every message for a message type, and determine whether it is able to process the message of that type or not, and messages that are not able to be processed are discarded.

According to one embodiment, a logical end-point is configured to be highly available (HA) having at least a first and a second HA pair of active and hot standby compute nodes, all of which are connected to a common network. Each HA pair of compute nodes comprising the logical end-point is configured to process messages of a particular type or types received over the network from a particular set of communication devices associated with one or more particular organizations in an enterprise. The logical end-point subscribes to receive messages over the service bus from two or more sets (work-set) of communication devices, each set of which can be associated with the same or different enterprise organization and each set being comprised of different communication devices. Depending upon how compute nodes are configured, a particular compute node can process some types of messages, and not process other types of messages. Regardless, each compute node sends a copy of every message it receives to one or more locations in a persistent storage system that can be examined by all of the compute nodes comprising the LEP.

Further, each compute node operating in a LEP can be configured to provide different services, such as a service for tracking the location of patients, nurses or devices, a rules processing service and a messaging service. So, for example, if a message having location tracking information is received by a compute node from a particular device, and the compute node is either not configured to provide location tracking services or not configured to provide this service to the particular device from which it received the message (i.e., msg. generated by organization not serviced by node), then this compute node is not able to process the message. However, each LEP comprising this HA nurse call system operates to store a persistent copy of every message it receives for each compute node to examine and to process if it is configured to do so.

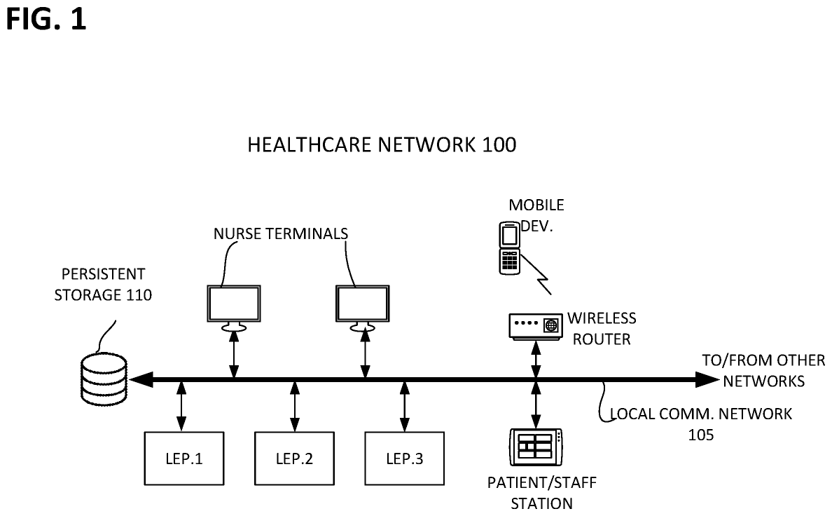

This and other embodiments are described with reference to the figures, in which FIG. 1 is a diagram showing a healthcare network 100 comprised of a local communication network 105 to which are connected a number of logical end-points, LEP.1, LEP.2 and LEP.3, a persistent storage system 110, a number of nurse terminals, a mobile communication device and wireless router, and a patient/staff station. It should be understood that the network 100 is not limited to the number of devices that are shown connected to it, as different embodiments can have more or fewer devices of any type connected to it. The persistent storage 110 described above can be any non-transitory medium that can be accessed by all of the compute nodes comprising each logical end point, LEP.

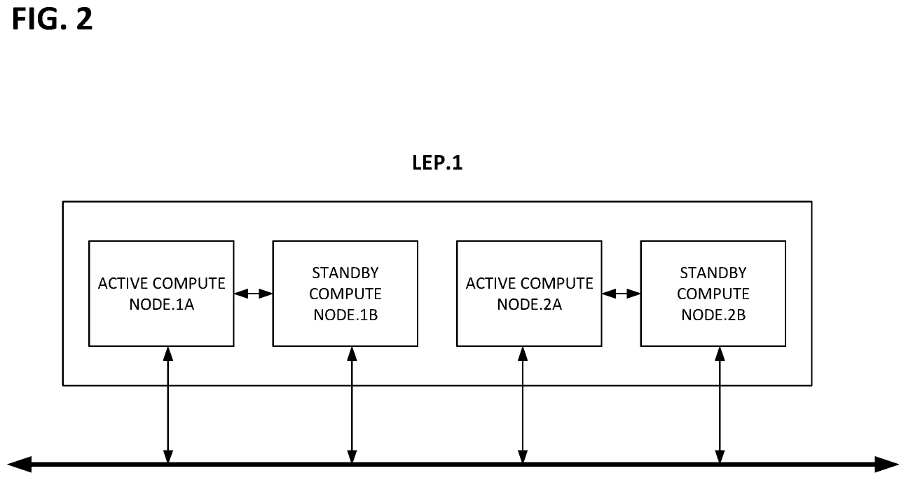

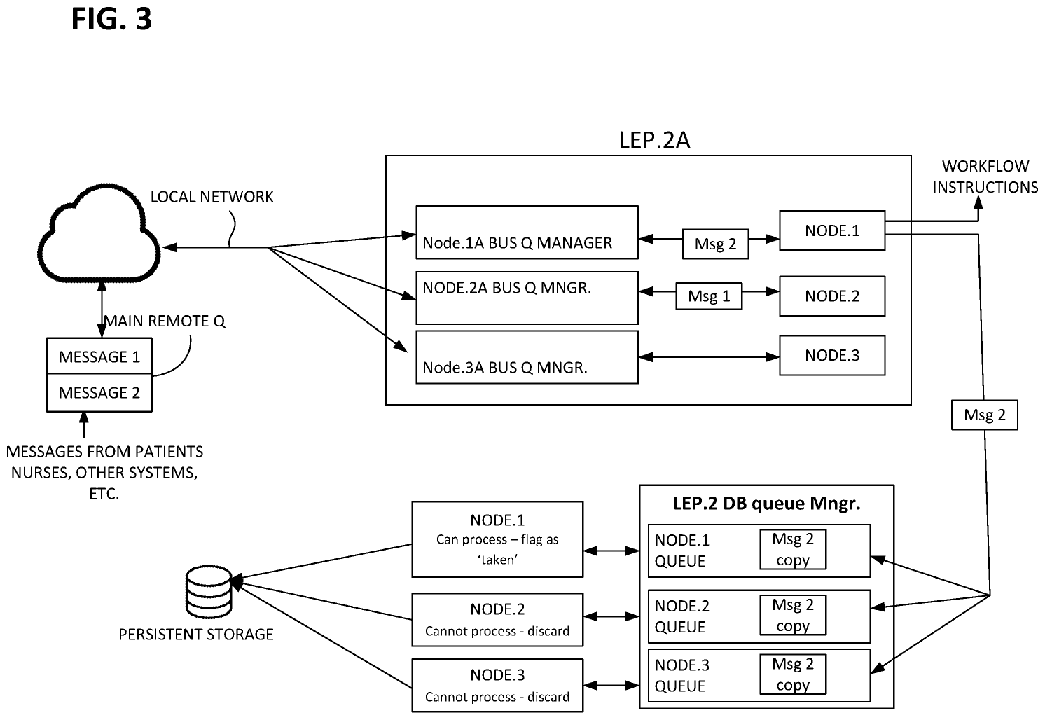

Continuing to refer to FIG. 1, the local network 105 can be any appropriate network that supports communication between devices connected to it and which supports inter-service/inter-application communication, such as the Nservicebus or NSB. The logical end points, LEP.1, LEP.2 and LEP.3 connected to the network 105 are each comprised of two or more active, compute nodes that will be described later in detail with reference to FIGS. 2 and 3. A persistent data storage system 110 that is connected to the service bus can be any type of relational or other type of dbase system that among other things operates to maintain compute node configuration information, messaging information, and other types of information relating to the operation of the network 100. The nurse terminals are hardware devices connected to the service bus that operate to receive instructions received from any of the LEPs that provide a healthcare provider with information about a patient or another healthcare provider, for example, or receive input information from a healthcare provider. The mobile device is any type of wireless communication device that is able to connect to the network 105 allowing a healthcare worker to respond to request generated by a nurse terminal, and the patient/staff station is a hardware device that operates, under the control of a patient or healthcare staff member, to generate signals (keyed or verbal) that are sent to a LEP for processing by an appropriate compute node. In operation, and depending upon the message transport implemented, a message can be generated by the patient station and sent to a subscribing LEP, or the message can be generated and placed in a queue at a network location (can be network 100 or a remote network) or some other location known to each of the LEPs. Regardless of the message transport means implemented, a message can be delivered randomly to one of the LEPs for processing by a compute node. Regardless of which compute node in any of the LEPs that receives the message, this compute node operates to store a persistent copy of the message in a location that can be examined by all of the compute nodes in the LEP, and each compute node can then determine individually whether they are configured to process the contents of the message.

Referring now to FIG. 2, which is a diagram showing an LEP implementation with a first message transport system, such as the Azure message transport. In this implementation, the LEP.1 has two active compute nodes, 1A and 2A, and two hot standby compute nodes, 1B and 2B. Each pair of compute nodes can be considered to be a HA computer system. The compute nodes 1A and 1B operate as a HA pair of compute nodes or HA computer system, and the compute nodes 2A and 2B also operate as a HA pair of compute nodes or HA computer system. The active node in each HA pair normally operates to process messages the node receives over the network 105 until such time that it is unable to process the messages, at which time the standby compute node transitions to be an active node, and the formerly active node transitions to be a standby node. The methodology employed to determine when the operational mode of each compute node is changed will not be discussed here, as the process for transitioning compute nodes between the active and the standby modes in a HA computer system is well known. According to the embodiment in FIG. 2, the LEP.1 can be configured to subscribe to messages generated by particular devices associated with a particular enterprise organization. For example, the LEP.1 can be configured to subscribe to message generated by a location tracking device associated with a particular healthcare functional group, such as the emergency room. Further, each of the HA pairs of compute nodes (A1/A2, B1/B2) can be configured to exclusively process messages generated by a particular set of devices. For example, the nodes 1A/1B can be configured to process messages generated by a first set of two or more location tracking devices located in a particular building or functional group (i.e., emergency rooms), and the nodes 2A/2B1 can be configured to process messages generated by a second set of two or more location tracking devices located in a particular building or functional group (i.e., pediatric care), and each the first and second sets being comprised of different devices. This compute node configuration information can be maintained in non-transitory computer memory that is local to the compute node, or it can be maintained remotely in a dbase accessible by the compute nodes over the network 105. In the case of the LEP.1 in FIG. 2, either of the active compute nodes, 1A or 2A can receive a message generated by a location tracking device associated with a particular emergency room. However, only compute node 1A is configured to process this type of message. So, in order to ensure that the information in this message is processed, and not simply dropped, it is necessary for each compute node in a LEP to send a copy of each message it receives to a persistent storage location that is accessible to each compute node comprising the LEP. Then, each compute node comprising the LEP can examine the contents of each message stored at this persistent location to determine if it is configured to process the contents of the message. The functionality comprising an LEP that can be used to implement this message processing methodology is described now with reference to FIG. 3.

LEP.2A in FIG. 3 is similar to the LEP.1 described with reference to FIG. 2, but LEP.2 has three active compute nodes labeled Node.1, Node.2 and Node.3. According to this embodiment, receiver side message distribution is employed wherein each compute node has a bus queue manager that operates to examine messages stored in a main remote queue for distribution to subscribing LEPs. Messages stored in the main remote queue are received from a variety of different devices in a variety of different locations, and a network address for the main remote queue is known to all devices that generate messages which can be processed by a compute node in the healthcare network 100. Each queue manager in the compute nodes comprising the LEP.2A compete for messages which are stored in the main remote queue to which the LEP.2A is subscribed. If the next message available in the main remote queue is a message 2, and assuming that this message is de-queued by the Node.1 bus queue manager, then Node.1 operates to send a copy of the de-queued message, via a LEP.2A database queue manager, to a unique location in persistent storage associated with each or all compute node(s) comprising the LEP, were it can be examined by the compute node(s) corresponding to that location. Subsequent to the message 2 being stored in persistent storage, each compute node can examine the message, check its configuration information, and if one of the nodes determines that it is configured to process message 2, that node can mark the message as “taken” or remove the message from persistent storage and process the message. The remaining nodes, not being able to process their copy of the message can simply remove or delete the message from the storage location associated with them. Messages generated by devices connected to a network 105 can be in any appropriate format that can be processed by a compute node. Each compute node has functionality that parses a message looking for information in the message corresponding to, among other things, the unique identity of the device that generated the message and for the identity of the enterprise organization with which the device is associated. Maintaining a persistent copy of each message received by an LEP that can be examined by each compute node comprising the LEP ensures that every message that is received by the LEP will be processed. Alternatively, a copy of the message can be sent to and maintained in persistent storage at a single location that is accessible by each node comprising the LEP. In this case, the message is maintained in persistent memory until one of the compute nodes is able to process it, at which point the message can be labeled as “taken” or deleted from the persistent storage location after some configurable period of time.

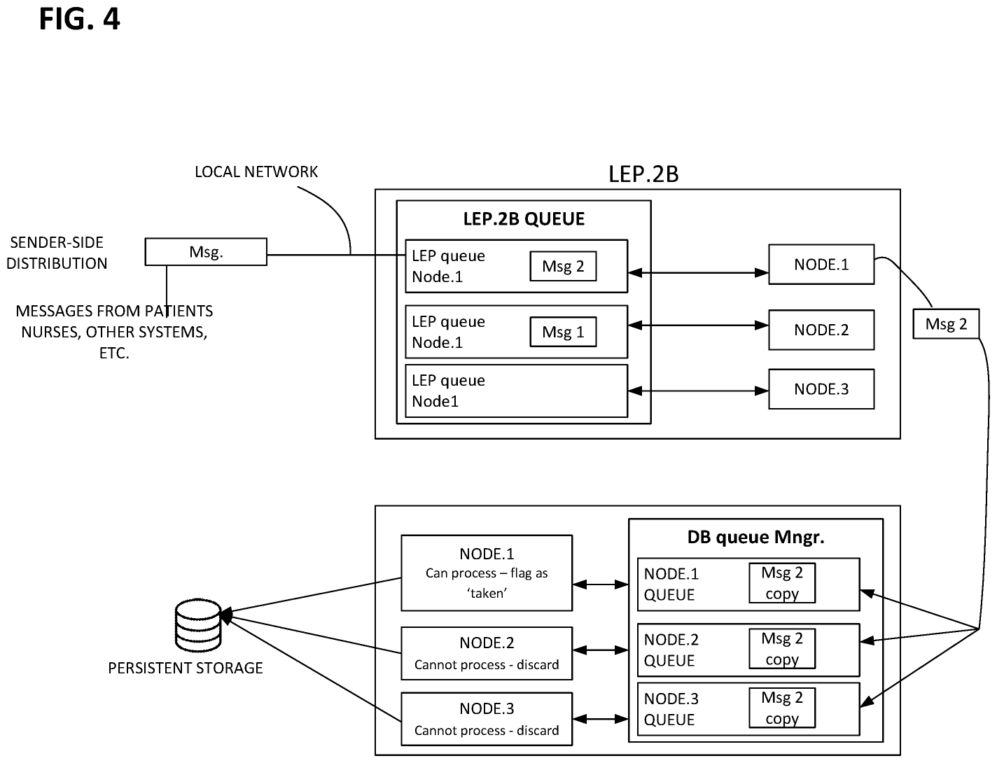

FIG. 4 is a diagram showing a logical end-point labeled LEP.2B that is similar to and generally operates in the same manner as the LEP.2A described with reference to FIG. 3, with the exception that each compute node in LEP.2B has a dedicated input queue for receiving messages over the local network. According to this embodiment, sender side message distribution is implemented and an LEP.2B queue dedicated to each node, Node.1, Node.2 and Node.3, randomly receives a message over the network. Regardless of which queue that receives a message, the node associated with that queue sends a copy of the message to a database queue manager which stores a copy of the message in a unique location in persistent memory assigned to each node in the LEP.2B. Each node in the LEP.2B can then examine the message to determine whether it is able to process the message.

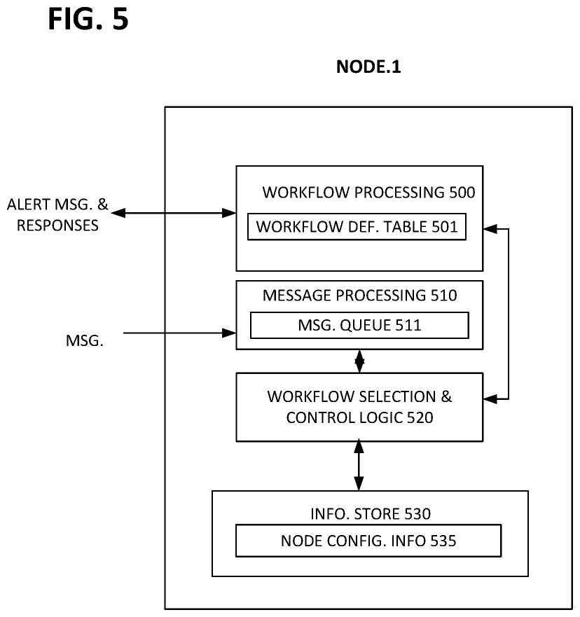

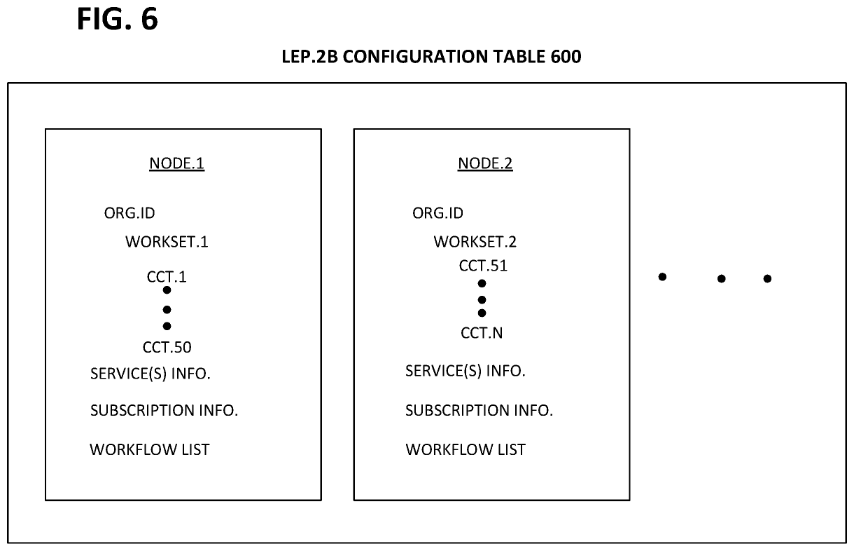

FIG. 5 is a diagram showing functional elements comprising an exemplary compute node, Node.1, in either the logical end point LEP.2A or 2B in this case. Node.1 is comprised of an input message processing module 510 having functionality that operates to manage a queue for receiving messages from the service bus, de-queue the message and send copies of each de-queued message to persistent storage where they are maintained in a queue assigned to each compute node (or a single queue) and available for examination by each compute node comprising a LEP. For example, Node.1 can be assigned space in a queue at a first location in persistent storage, Node.2 can be assigned space in a queue at a second location in persistent storage, and Node.3 at can be assigned space in a queue at a third location in persistent storage. Alternatively, all three nodes can be assigned the same space in persistent storage. Node.1 also has a module with workflow selection and control logic functionality 520 that operates to parse a message and to examine the parsed contents of each message maintained in persistent storage associated with it. This module 520 also operates to examine a node configuration table 535 maintained at a location in a persistent memory store 530 associated with the node, or maintained at a location in persistent memory comprising a remote dBase system accessible by the Node.1. As described in more detail with reference to FIG. 6, the configuration table has information about the type or types of services provided by a compute node, it can have subscription information, it can have an identity or identities of devices (can be a unique work-set ID) from which it can receive messages and the identity of an enterprise organization to which the device or work-set is assigned, and it can maintain a listing of the types of workflows that can be supported on the node. Finally, the Node.1 has a workflow processing function 500 that uses information comprising messages that the node is configured to process to initiate an appropriate workflow. The result of a workflow can be an instruction sent to a device or to a healthcare worker.

Continuing to refer to FIG. 5, the control logic 520 first examines a message to identify a unique organizational ID, and if an examination of configuration information indicates that the organizational identity is included, then it can proceed further. If a workload is only divided up by organization, then the compute node can process the message. Otherwise, the logic 520 can examine the message for a work-set ID, and compare the work-set identity to the identity of the work-sets the compute node is configured to process. For example, a NurseCall service handles connections to CCTs (central control terminals) in a hospital, from which it receives patient calls from patient stations. We may divide up the NurseCall connections within the same organization, to be processed by multiple compute node. One node may process a first work-set, which consists of 50 CCTs (central control terminals) within a single organization facility. A second node may process a second work-set, which includes the remaining 33 CCTs in that facility. Because all the CCTs are associated with the same facility and organization, but each node is configured to process message arriving over different connection, it is necessary to configure two work-sets: one with 50 CCTs, the other with the last 33.

FIG. 6 illustrates a configuration table 600 format that can be used to maintain configuration information for nodes comprising a LEP, such as the nodes comprising the LEP.2B. Each node, Node.1 and Node.2, in the table 600 has, among other things, information corresponding to a unique organizational identity and information corresponding to the unique identity of two work-sets in this case, although more than two work-sets can be defined. Each work-set can be comprised of some number of devices, labeled CCT.1 to CCT.N (with N being an integer number, and the acronym CCT standing for central control terminal), which are connected to the network 105 comprising the healthcare network 100. Each CCT can operate to receive messages from patient or staff station devices having information corresponding to a patient health, for example.

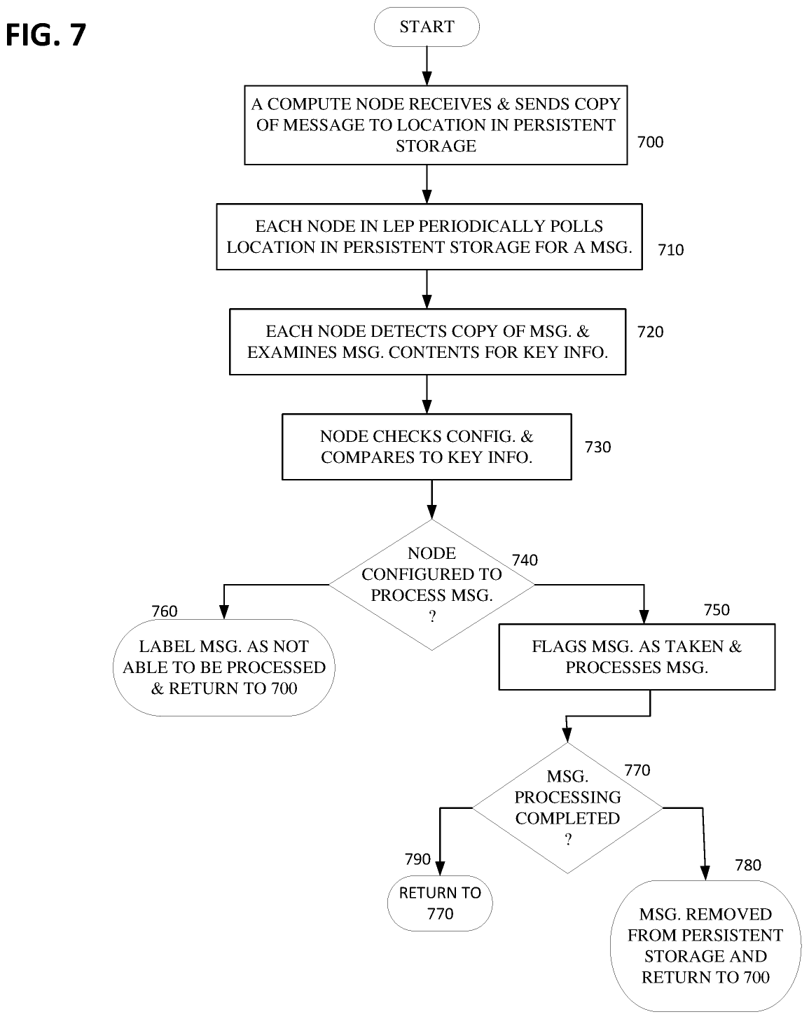

FIG. 7 is a diagram illustrating the logical process followed by any compute node comprising an LEP to dequeue and process a message. For the purposes of this description, it is assumed that each node comprising an LEP is assigned a unique location in persistent memory in which to store a copy of a message. At 700 a compute node operates to receive a message over the network 105 and to copy and send the message to a location in persistent storage either assigned exclusively to it, or that is assigned to all compute nodes comprising the LEP. At 710, each compute node comprising the LEP periodically examines the location in persistent memory assigned to it for a copy of a message. When, at 720, a compute node detects a message in its persistent memory location, it will examine the contents of the message for key information (i.e., organizational ID, Work-Set ID, etc.). Then, at 730 the node can examine its configuration information. and compare the key message information to the configuration information in order to determine whether it is configured to process the message. If at 740 the node determines that it is configured to process the message, at 750 the mode can mark the message as “Taken” and start to process the message. On the other hand, if at 740 the node determines that it is not able to process the message, then at 760 the node labels the message as “not able to be processed”. At 770, when the node successfully processes the message, the node can remove the message from persistent memory (after some configurable period of time) and the process returns to 700, otherwise the process loops at 770 until the message processing has completed.

It should be understood, that the process described with reference to FIG. 7 is followed by each compute node comprising an LEP. Each compute node comprising an LEP is operating independently to process messages it receives over the service bus, and in order to be certain that every message is processed, and that every message is processed only once, each compute node is configured to process different types of messages, and each compute node operates to send a copy of every message it receives to a location in persistent storage that can be examined by every other node comprising the LEP, and in this manner, the message is guaranteed to be processed, and to be processed only once.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for conditionally processing a message in a nurse call system, comprising:
configuring each of a first and a second active and hot-standby compute node pairs comprising a logical end-point in the nurse call system to conditionally process different types of messages received over a common communication network, wherein the configuring comprises assigning configuration information to each pair of compute nodes and storing the configuration information in a non-transitory, computer readable medium;
receiving a message by either the first or the second active compute node, the active compute node that receives the message copying it and storing the message copy in at least one location in the non-transitory computer readable medium that is accessible by both the first and the second active compute nodes;
periodically examining, by the first and the second active compute nodes, the at least one location in the non-transitory computer readable medium for the message, parsing the stored message for key message type information, and each compute node examining the configuration information associated with it;
comparing, by both the first and the second active compute nodes, the key message type information to the associated configuration information, and the first or the second active compute node determining that it is configured to process the message; and
processing the message by the active compute node configured to process the message, and labelling the message as being processed.

2. The method of claim 1, further comprising the active compute node configured to process the message generating one or more computer instructions which when sent to the nurse call system cause it to perform some action.

3. The method of claim 1, further comprising the active compute node configured to process the message marking the stored message as being taken at least during the time that it is processing the message.

4. The method of claim 1, wherein the different message types are identified by the key message information.

5. The method of claim 1, wherein the conditions determining whether an active compute node is able to process a message are one or more of the key message information.

6. The method of claim 5, wherein the one or more of the key message information is comprised of an organizational identity and a work-set identity.

7. The method of claim 6, wherein a work-set is a configurable number of unique connections from the first of second active compute nodes to the common communication network.

8. The method of claim 1, wherein each compute node comprising the logical end-point comprises service bus functionality that operates to permit communication between each of the compute nodes.

9. The method of claim 8, wherein the service bus does not support sending the message to both the first and the second active compute nodes.

10. A method for conditionally processing a message in a nurse call system, comprising:
configuring each of a first and a second active and hot-standby compute node pairs comprising a logical end-point in the nurse call system to conditionally process different types of messages received over a common communication network, wherein the configuring comprises assigning configuration information to each pair of compute nodes and storing the configuration information in a non-transitory, computer readable medium;
receiving a message by either the first of the second active compute nodes, the active compute node that receives the message copying it and storing the message copy in at least one location in the non-transitory computer readable medium that is accessible by both the first and the second active compute nodes;
periodically examining, by the first and the second active compute nodes, the at least one location in the non-transitory computer readable medium for the message, parsing the stored message for key message type information, and each compute node examining the configuration information associated with it;
comparing, by both the first and the second active compute nodes, the key message type information to the associated configuration information, and the first active compute node determining that it is configured to process the message, and the second active compute node determining that it is not able to process the message; and
processing the message by the first active compute node.

11. The method of claim 10, further comprising the first active compute node marking the stored message as being taken at least during the time that it is processing the message.

12. The method of claim 10, further comprising the first active compute node generating one or more computer instructions which when sent to the nurse call system cause it to perform some action.

13. The method of claim 10, wherein the different message types are identified by the key message information.

14. The method of claim 10, wherein the conditions determining whether an active compute node is able to process a message are one or more of the key message information.

15. The method of claim 14, wherein the one or more of the key message information is an organizational identity and a work-set identity.

16. The method of claim 15, wherein a work-set is a configurable number of unique connections from the first or second active compute nodes to the common communication network.

17. The method of claim 10, wherein each compute node comprising the logical end-point comprises service bus functionality that operates to permit communication between each of the compute nodes.

18. The method of claim 17, wherein the service bus does not support the conditional communication between the compute nodes.

19. A nurse call system, comprising:
first and a second active and hot-standby compute node pairs comprising a logical end-point that is connected to a plurality of message generating devices over a common communication network;
each of the compute nodes are connected over the common communication network to a non-transitory computer readable medium that maintains configuration information corresponding to each pair of compute nodes and maintains a copy of a message that is received over the common communication network by either the first or the second active compute nodes, and either of the compute nodes operating to store a copy of the message at a location in the non-transitory computer readable medium that is accessible by each compute node;
wherein, the configuration information corresponding to each pair of compute nodes conditionally enables each pair of compute nodes to process different types of messages.
